(19) United States
(12) Patent Application Publication
(10) Pub. No.: US 2024/0369116 A1
(43) Pub. Date: Nov. 7, 2024

(54) BRAKE ELEMENT FOR A MOTOR VEHICLE, AND METHOD FOR MANUFACTURING A BRAKE ELEMENT

(71) Applicant: Volkswagen Aktiengesellschaft, Wolfsburg (DE)

(72) Inventor: Markus HARKE, Braunschweig (DE)

(73) Assignee: Volkswagen Aktiengesellschaft, Wolfsburg (DE)

(21) Appl. No.: 18/655,049

(22) Filed: May 3, 2024

(30) Foreign Application Priority Data
May 3, 2023 (DE) 10 2023 204 087.5

(51) Int. Cl. F16D 65/12; C23C 24/10; F16D 65/02; F16D 69/02

(52) U.S. Cl. CPC F16D 65/127; C23C 24/103; F16D 69/027; F16D 2065/132; F16D 2065/1328; F16D 2200/0008; F16D 2200/0013; F16D 2250/0046

(57) ABSTRACT

A brake element for a motor vehicle, having a base body that is planar at least in areas, to the planar sides (of which at least two build-up layers are applied in each case, at least in areas. The build-up layers form a surface which, in the mounted state of the brake element on the motor vehicle, is used as a friction surface for a brake pad. There is a bonding zone in which both a material of the base body and a material of a build-up layer adjacent thereto are present. The second build-up layer is made of a composite of an iron alloy matrix with intercalated tungsten carbide particles. A proportion of the volume of the intercalated tungsten carbide particles to the volume of the iron alloy matrix is in a range of 1% to 19%.

This nonprovisional application claims priority under 35 U.S.C. § 119 (a) to German Patent Application No. 10 2023 204 087.5, which was filed in Germany on May 3, 2023, and which is herein incorporated by reference.

### BACKGROUND OF THE INVENTION

### Field of the Invention

The invention relates to a brake element for a motor vehicle. The invention further relates to a method for manufacturing such a brake element having the features.

### Description of the Background Art

Brake elements, for example brake discs or brake disc friction rings, are typically manufactured from gray cast iron. The benefits of gray cast iron, in particular the high volumetric heat capacity and the relative thermal shock resistance, are offset by various drawbacks. These include the high weight, the pronounced tendency for corrosion, and the high level of wear on the material during operation of a motor vehicle.

Corrosion results in an impaired appearance, since the brake element is the only part in the motor vehicle that forms red rust within a short period of time. In addition, brake discs are directly visible through the open aluminum wheel rims that are often used.

For economical driving or for large amounts of regeneration (when braking is only seldom performed), the tendency of the material to corrode may possibly result in such severe damage to the brake element that it must be replaced prematurely.

Furthermore, the friction wear on a brake element results in emissions of fine particulate matter which can greatly exceed those from a modern internal combustion engine.

To eliminate these disadvantages, previous known approaches have been to completely substitute the material of the brake element with hard, corrosion-resistant materials (ceramic, for example) and also to protect the friction surfaces of the brake element with a suitable coating.

Thus, there are various problem-solving approaches for coatings, in particular the friction surfaces of the brake element that are subject to particular wear, which are intended for use as combined wear protection and corrosion protection. The coating takes place using thermal spraying processes to apply oxide ceramic coatings or coatings containing hard materials. Various coating materials based on metallic alloys or composites of ceramic or hard metal particles, which have improved behavior with regard to corrosion and wear, are thus used in the metallic matrix.

Examples of thermal spraying processes include high-velocity slurry spraying, plasma spraying, cold gas spraying, or wire arc spraying.

A frequent problem with thermally sprayed coatings is the adhesion of the layer to the substrate under the high thermomechanical loads that act on the brake element. To this end, approaches are known in which prior to the thermal spraying, the surface of the brake element is roughened by abrasive blasting with hard material granules (DE 10 2008 035 894 A1), by ultrasonic/laser beam treatment (DE 10 2011 089 152 A1), or by electron beam treatment (DE 10 2011 012 320 A1, which corresponds to US 2013/0333989).

To increase the adhesion of the thermally sprayed coating, it is further known to use an adhesion promoter layer as an intermediate layer. This is known from DE 10 2011 089 923 A1, for example, in which a chemically or electrochemically cold-deposited intermediate layer of nickel, copper, and/or chromium is described as the basis for a thermally sprayed wear protection layer.

Regardless of the roughening method or the use of an intermediate layer, the adhesion of a thermally sprayed layer is based almost exclusively on the principle of mechanical grouting of the spray particles striking the substrate.

Significantly stronger bonding is possible using a metallurgical bond, for which it is necessary to use thermal energy to enable the atomic diffusion process at the boundary surface between the substrate and the coating. Two alternatives are available for selection:

On the one hand, the substrate may be heated prior to the spraying process, so that the diffusion process can take place directly when the spray particles strike (see DE 10 2008 035 849 A1, for example).

On the other hand, the second option is a melting process in which the heating takes place after the spraying operation, as described in DE 10 2005 008 569 A1.

A disadvantage of the injection process is a very complicated additional process step, since high temperatures are required and the process must be carried out in part in a vacuum furnace.

Besides the thermally sprayed coatings, an electrolytically applied coating is described in DE 10 2006 035 948 A1, in which hard materials are embedded in a ductile metallic matrix. Possible problems with this approach are poor adhesion and very low ductility of the coating, which may result in the coating chipping off during operation. In addition, for process-related reasons it is difficult and costly to achieve the required layer thicknesses.

As a further alternative, DE 10 345 000 A1 describes a build-up welding method using laser beam welding, plasma welding, or arc build-up welding for a wear protection layer. The carrier material (substrate) is melted using an energy source, and the coating material is supplied in the solid state to the molten pool. Alternatively, it is proposed to melt the carrier material after the coating material is applied. The coating may be made of a metallic, ceramic, or composite material, and may be applied over the entire surface or also in strips. Due to locally large temperature changes as a result of the process, pronounced cracks may appear in coatings with high hardness or high proportions of hard material components, and such cracks allow the penetration of corrosive media to the base material and represent a significant impairment of appearance.

EP 3 034 902 B1, which corresponds to US 2016/0223041, describes a multilayer coating for brake discs by use of laser build-up welding. A base layer which contains no high-melting particles is applied directly to the brake disc. A further layer which contains particles with a higher melting point than the main disc element of the brake disc is then applied to this base layer.

A brake disc for a friction brake of a motor vehicle, having a base body, is known from DE 10 2019 208 411 A1. The base body is provided with a wear protection layer that contains hard material particles and is applied over a frictional contact surface. An intermediate layer of austenitic or semi-austenitic chromium-nickel steel is present between the frictional contact surface and the wear protection layer. The intermediate layer is applied to the base body by laser build-up welding. As base material, in addition to iron the intermediate layer contains at least 10 wt % chromium and at least 4 wt % nickel, and has a layer thickness of less than 150 μm. The wear protection layer is formed from a chromium steel matrix in which ceramic particles, preferably carbide particles, are intercalated.

A coated brake disc and a manufacturing method for same are known from DE 10 2014 015 474 A1. In particular, the brake disc is made of a gray cast iron substrate with multiple surface layers situated thereon. The surface layers include an adhesive layer to which a corrosion layer, an optional oxide layer, and a wear protection coating or friction coating are applied. The adhesive layer is made of a material of the gray cast iron substrate with a proportion of chromium or molybdenum that is increased to 20 to 60 wt %, the predominant portion of the lamellar carbon of the gray cast iron being chemically bound in the adhesive layer as Cr carbide and/or Mo carbide. The corrosion protection layer is made of a nitrated, nitrided, or nitrocarburized adhesive layer material. The wear protection layer or friction layer that is present following the optional oxide layer is made of oxide ceramic or a so-called cermet material made of ceramic material in a metallic matrix. 1.4404 austenitic stainless steel (EN 10027-2) or 316L austenitic stainless steel (AISI) is stated as a metallic matrix. The adhesive layer is produced by remelting the surface of the gray cast iron substrate that is acted on by Cr and/or Mo particles.

Lastly, a brake element for a motor vehicle having the features of the preamble of claim 1 and a method for manufacturing a brake element having the features of the preamble of claim 8 are known from DE 10 2021 207 133 B3, which corresponds to US 2023/0013186, which is incorporated herein by reference, by the present applicant.

### SUMMARY OF THE INVENTION

It is therefore an object of the present invention to provide a brake element for a motor vehicle that has a coating with high wear resistance and high corrosion protection and that is economically manufacturable. In particular, the brake element is intended to be economically manufacturable with high wear resistance, low tendency for cracking of the second build-up layer due to thermomechanical action, and good emission values (fine particulate matter). Moreover, the object of the present invention is to propose a method for manufacturing such a brake element that can be carried out in a cost-effective manner. In particular, preferred layer thicknesses of the brake element are to be achieved with good process reliability.

The above objects are achieved by a brake element having a base body that is planar at least in areas, to the planar sides of which at least two build-up layers are applied in each case, at least in areas (i.e., at least in the region of the area that is covered by the brake pad). The build-up layers form a surface which, in the mounted state of the brake element on the motor vehicle, is used as a friction surface for a brake pad. In addition, there is a bonding zone in which both a material of the base body and a material of a build-up layer adjacent thereto are present. A first build-up layer is present that adjoins the base body, and a second build-up layer is present that is applied to the first build-up layer. The second build-up layer is made of a composite of an iron alloy matrix with intercalated tungsten carbide particles.

According to the invention, it is proposed that the proportion of the volume of the intercalated tungsten carbide particles to the volume of the iron alloy matrix is in a range of approximately 1 percent to approximately 19 percent, preferably in a range of approximately 8 percent to approximately 18 percent. A range of approximately 10 percent to approximately 15 percent is particularly preferably proposed.

It has surprisingly been shown in numerous tests that with such low ranges, good results with regard to wear resistance, corrosion protection, good friction coefficients during use of the brake element, and low emission values may be achieved, and at the same time the manufacturing costs for the brake element may be lowered.

The bonding zone can have a thickness, perpendicular to an areal extent of a planar side, that is less than 10 microns, preferably less than 5 microns.

In other words, in this region of the coating the brake element has a degree of blending (proportion of the material of the base body in the material of the adjacent build-up layer) that is very low.

Due to the presence of such a bonding zone having the stated thickness, negative effects (granulation, hardening) which may occur due to blending of the substrate material may be prevented. Nevertheless, good adhesion of the build-up layer to the base body may be obtained, with adhesive tensile strengths of well above 50 MPa being achievable. This contributes to high wear resistance and a high level of corrosion protection.

A brake disc or a brake disc friction ring, for example, may be understood as a brake element.

The first build-up layer, viewed perpendicularly with respect to an areal extent of a planar side, can have a thickness in a range of approximately 50 microns to approximately 350 microns, preferably a thickness in a range of approximately 80 microns to approximately 350 microns, particularly preferably in a range of approximately 121 microns to approximately 350 microns, and very particularly preferably in a range of approximately 121 microns to approximately 220 microns.

The second build-up layer, viewed perpendicularly with respect to an areal extent of a planar side, can have a thickness in a range of approximately 60 microns to approximately 420 microns, preferably a thickness in a range of approximately 80 microns to approximately 400 microns.

It has been shown that when such thicknesses of the build-up layers are achieved, the first build-up layer can optimally fulfill the purpose of corrosion protection and inhibition of cracks from the second build-up layer.

Due to the stated thickness range, high wear resistance may be achieved with the second build-up layer, resulting in a considerable reduction in the particulate emissions from the abrasion wear on the brake element.

The first build-up layer can be made of an austenitic chromium-nickel-molybdenum steel. This steel has special ductile and toughness properties via which crack propagation may be stopped and the base body of the brake element may thus be better protected. This protection is essential for safeguarding the substrate (the base body) from corrosive attack and ensuring long life of the overall brake element.

It has turned out to be particularly advantageous when the material of the first build-up layer has material properties corresponding to the material 1.4404 according to the EN 10027-2 standard, or to the material 316L according to the AISI standard.

As a material for the iron alloy matrix, it has likewise proven advantageous here when the iron alloy matrix is made of a material that has material properties corresponding to the material 1.4404 according to the stated EN 10027-2 standard, or to the material 316L according to the stated AISI standard.

As mentioned at the outset, the invention also relates to a method for manufacturing a brake element according to the invention. This method proceeds from a method for manufacturing a brake element, in a first method step at least one energy beam being directed onto a planar side of a planar base body of the brake element by means of at least one energy source. The at least one energy beam may be selected in the form of a light beam (a laser beam, for example) or also in the form of an electron beam. Under some circumstances, a plasma beam may also be conceivable, although it is much more difficult to control or meter. In any case, this is a high-energy energy beam.

Furthermore, in the first method step a first powdered coating material is supplied to a position that is acted on by the energy beam in order to melt the first coating material and thus coat the planar side of the planar base body of the brake element with a first build-up layer.

After the first build-up layer is applied, in a second method step at least one (preferably likewise high-energy) energy beam is directed onto a surface of the first build-up layer by means of the at least one energy source. A second powdered coating material is supplied to a position that is acted on by the at least one energy beam in order to melt the second coating material and coat the first build-up layer with a second build-up layer.

To allow the preferred layer thicknesses of the brake element to be achieved with good process reliability, according to features of the invention it is proposed that the powdered coating material is supplied at a powder mass flow in a range of approximately 60 g/min to approximately 400 g/min, preferably in a range of approximately 150 g/min to approximately 400 g/min, particularly preferably in a range of approximately 225 g/min to approximately 400 g/min.

A radiation intensity of the energy beam, at least in the second method step when generating the second build-up layer, can be held in a range of approximately 700 W/mm² to approximately 1700 W/mm², preferably in a range of approximately 1000 W/mm² to approximately 1700 W/mm², particularly preferably in a range of approximately 1505 W/mm² to approximately 1700 W/mm².

It has been shown that by maintaining such a range of the radiation intensity (i.e., the radiation power based on the beam spot diameter on the substrate surface), it may be ensured that the second build-up layer does not overheat. Namely, overheating causes the tungsten carbide, as a solid phase, to dissolve into a liquid phase and to remain dissolved in the iron alloy matrix of the second build-up layer. As a result of the dissolved material, the material of the iron alloy matrix becomes so strongly embrittled that cracks develop.

As a result of the selected radiation intensity, an optimal coating result with optimal quality and with optimal adhesion of the build-up layer may thus be achieved.

At least in the second method step, the energy beam can be delivered to the particular substrate in such a way that a laser spot having an outer diameter in a range of approximately 2 mm to approximately 7 mm, preferably with an outer diameter in a range of approximately 3.1 mm to approximately 7 mm, and particularly preferably in a range of approximately 3.2 mm to approximately 5 mm, results at the area of impact of the energy beam on the particular substrate. The creation of an intensity distribution of the energy beam or of the laser spot with a top hat profile is conceivable. A circular top hat profile may also very advantageously be created in which the intensity of the energy beam is reduced in the center of the laser spot.

A top hat profile is a profile in which the intensity distribution of the energy beam (beam spot) striking the substrate, viewed over the diameter of the incident energy beam, has an approximately constant height. The intensity distribution thus increases abruptly, in the manner of a rectangular profile, from the value zero to a maximum value, remains approximately constant over the diameter of the laser beam, and abruptly drops back to the value zero.

The surface roughness of the produced build-up layer may be greatly reduced in this way. This ultimately results in a possible decrease in removed material in a subsequent grinding process on the surface, and thus in further lowering of the costs.

The powder grains of the coating material are preferably present in a spherical (ball-shaped) form, and are preferably selected in a size range of approximately 10 μm to approximately 90 μm, particularly preferably in a range of approximately 15 μm to 50 μm.

Also, for applying the build-up layers, the brake element can be oriented with its planar sides horizontal and is set in rotation. The energy beam and also the particular coating material are supplied from above to a planar side of the brake element. In other words, the supplying of the energy beam and the supplying of the coating material are oriented at least essentially in the direction of the acting weight force.

This allows the coating material to be exposed to the energy beam as long as possible, and thus to interact with the energy beam in an optimal manner.

For optimal heat development in the brake element during application of the build-up layers, it has proven advantageous for the application of the build-up layers to take place via a radial feed motion of a coating tool from the inside to the outside.

With regard to cost-effective manufacture, it has proven advantageous when the radial feed motion of the coating tool takes place at a speed above approximately 90 m/min, preferably above approximately 100 m/min.

To ensure on the one hand that the method is carried out quickly, and on the other hand that the base body is coated without gaps, it has proven advantageous when a radial feed motion of the coating tool and a rotational speed of the brake element are coordinated with one another in such a way that, during a complete rotation of the brake element, an overlap of a coating track that is applied during the rotation and a previously applied coating track (i.e., applied during a preceding complete rotation) in a range of approximately 70 percent to approximately 95 percent, preferably in a range of approximately 70 percent to approximately 90 percent, and particularly preferably in a range of approximately 70 percent to approximately 84 percent, is obtained.

Further, in the second method step, i.e., during the production of the second build-up layer using the second powdered coating material, a powdered material containing the tungsten carbide particles can be supplied at a higher speed than a powdered material containing the particles of the iron alloy matrix. For this purpose, the conveying line of the two supplied powdered materials preferably has a separate design up to the nozzle, and different quantities of conveying gas are used for the powders.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a motor vehicle with a brake element according to the invention,

FIG. 2 shows a cross section of a brake element illustrated individually,

FIG. 3 shows a detailed illustration according to detail Ill from FIG. 2,

FIG. 4 shows the illustration of a process step in the method for manufacturing the brake element,

FIG. 5 shows the illustration of on intensity distribution of the energy beam on the particular substrate, and

FIG. 6 shows the illustration of an alternative intensity distribution of the energy beam on the particular substrate.

### DETAILED DESCRIPTION

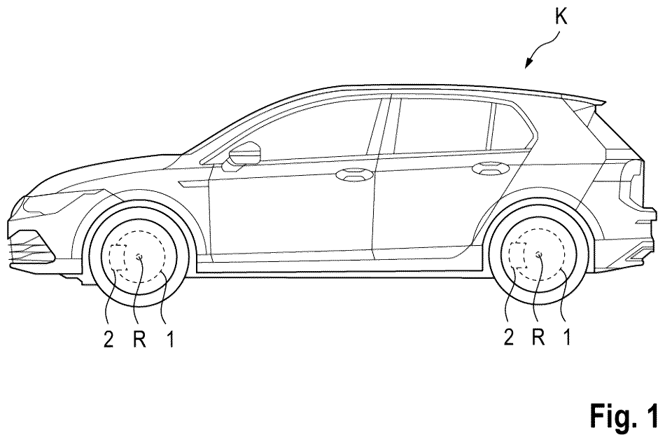

Reference is first made to FIG. 1, which shows a motor vehicle K that is equipped with brake elements 1 according to the invention. The brake elements 1 are designed as disc brakes, and are mounted on a wheel carrier and rotate about a rotational axis R. Brake calipers 2 each contain movable brake pads for which the brake element 1 via its brake disc friction rings forms a friction surface. When the brake pads are pressed against the friction surface of the brake element 1, the motor vehicle K is decelerated or stopped.

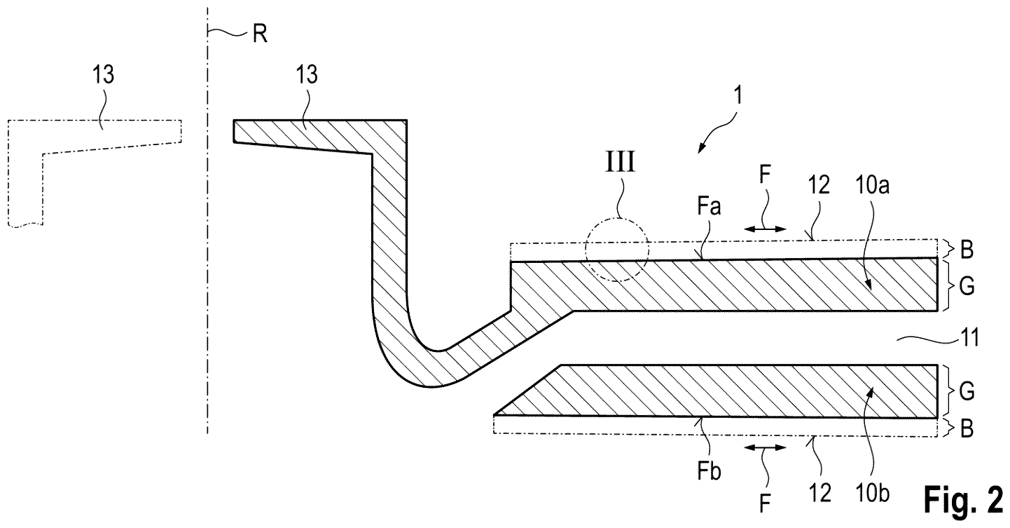

FIG. 2 shows a brake element 1 in an individual illustration, in cross section. The brake element 1 rotates about the imaginary rotational axis R. For reasons of rotational symmetry, only half of the brake element 1 is illustrated.

It is apparent that the brake element 1 in the exemplary embodiment is designed as an internally vented brake disc having two friction rings 10a and 10b. In a departure from the exemplary embodiment, a brake disc with only one friction ring is also conceivable. A ventilation space 11 is present between the friction rings 10a, 10b. Necessary spacer ribs are arranged between the friction rings 10a, 10b. Each friction ring 10a, 10b has a planar base body G with a planar side Fa or Fb. Each planar side Fa, Fb has an areal extent F and is provided with a coating B. The coating B in each case forms a friction surface 12 that is active during braking.

In the exemplary embodiment, the coating B in each case extends over the entire planar side Fa or Fb of the base body G. In a departure therefrom, it is also conceivable for the coating B to be applied only to the region of the planar sides Fa, Fb that is covered by the brake pads.

Reference numeral 13 denotes a hub of the brake element 1 that is used for mounting the brake element 1 on a wheel carrier.

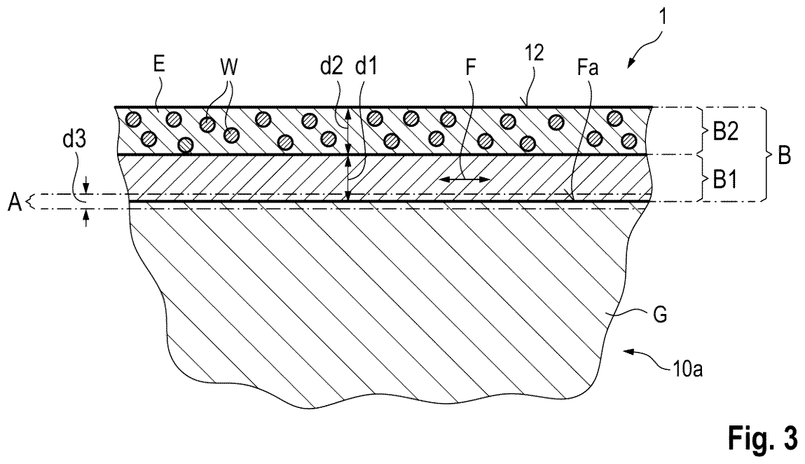

A detail area from the cross section of the brake element 1 is apparent from FIG. 3. In particular, it is discernible that the coating B is made up of a first build-up layer B1 and a second build-up layer B2.

The first build-up layer B1 is applied directly to the base body G, and thus directly adjoins it. The second build-up layer B2 is in turn applied to the first build-up layer B1.

It is indicated here that the first build-up layer B1 has a thickness d1 perpendicular to the areal extent F of the planar side Fa (or Fb). This thickness is preferably in a range of approximately 50 microns to approximately 350 microns. The first build-up layer B1 particularly preferably has a thickness d1 in a range of approximately 80 microns to approximately 350 microns, even more preferably in a range of approximately 121 microns to approximately 350 microns, and very particularly preferably in a range of approximately 121 microns to approximately 220 microns.

In contrast, the second build-up layer B2 has a thickness d2 that is preferably in a range of approximately 60 microns to approximately 420 microns. The thickness d2 is particularly preferably in a range of approximately 80 microns to approximately 400 microns.

As a result of these layer thickness ranges, the first build-up layer B1 can optimally fulfill the purpose of corrosion protection and inhibition of cracks from the second build-up layer B2.

The stated thickness range of the second build-up layer B2 meets the requirement for high wear resistance, as a result of which particulate emissions due to friction wear may be greatly reduced.

Furthermore, a bonding zone A is indicated which lies in a transition between the base body G and the adjoining first build-up layer B1. The bonding zone A is characterized in that a certain amount of blending takes place here between the material of the base body G and the material of the coating B1. The bonding zone A has a thickness d3, perpendicular to the areal extent F, which is very thin and less than 10 microns. The bonding zone A preferably has a thickness d3 that is less than only 5 microns.

It has been shown that due to such a small thickness of the bonding zone A, on the one hand granulation and hardening of the first build-up layer B1 may be prevented, and on the other hand good adhesion of the first build-up layer B1 to the base body G is still achievable. Adhesive tensile strengths of well above 50 MPa may be achieved. The basic requirements for high wear resistance and a high level of corrosion protection may thus be provided.

A more detailed discussion of the materials used is provided below. The base body G is manufactured from gray cast iron. Together with the hub 13 (see FIG. 2), it is manufactured using a conventional casting process. The first build-up layer B1 is made of an austenitic chromium-nickel-molybdenum steel, which thus represents a particularly ductile, tough iron alloy.

The material of the first build-up layer B1 particularly preferably has material properties corresponding to the material 1.4404 according to the EN 10027-2 standard, or to the material 316L according to the AISI standard.

The second build-up layer B2 is made of a composite of an iron alloy matrix E with intercalated tungsten carbide particles W. It has been found to be particularly advantageous when the proportion of the volume of the intercalated tungsten carbide particles W to the volume of the iron alloy matrix E in the second build-up layer B2 is in a range of approximately 1 percent to approximately 19 percent. The proportion of the volume of the intercalated tungsten carbide particles W is preferably in a range of approximately 8 percent to approximately 18 percent, and particularly preferably in a range of approximately 10 percent to approximately 15 percent, of the volume of the iron alloy matrix E.

As the result of such a volume distribution, on the one hand an increased tendency for crack formation in the second build-up layer B2 may be prevented, and on the other hand the wear on the second build-up layer B2 may be limited, with good friction coefficients and low emission values.

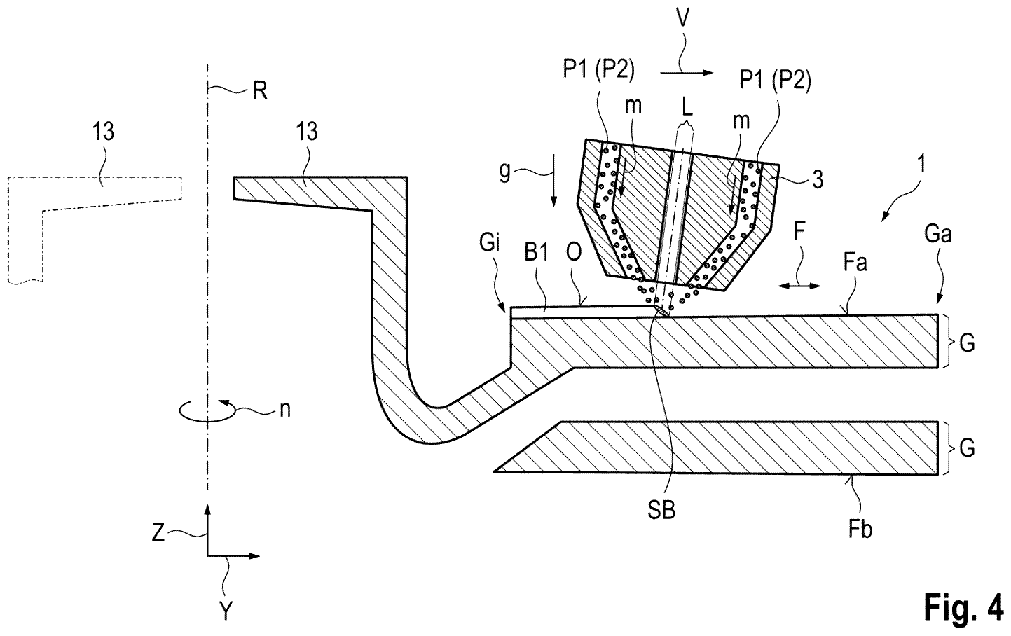

A first process step in manufacturing the coating B (see FIG. 3) of the brake element 1 is now explained with reference to FIG. 4. First, by use of a exemplary device, the base body G of the brake element 1 is oriented with its rotational axis R vertical, i.e., oriented in a vertical direction Z, in such a way that the planar side Fa with its areal extent F is oriented in parallel to a horizontal direction Y.

The base body G, i.e., the uncoated brake disc, has previously been manufactured according to a customary series production process (not explained in greater detail).

A coating tool 3 is present, approximately parallel to the rotational axis R. The coating tool 3 is uniaxially movable, orthogonally or radially with respect to the rotational axis R and in parallel to the horizontal direction Y. The coating tool has at least one laser optics system for generating a laser beam L, and a nozzle for ejecting a first powdered coating material P1 (or a second powdered coating material P2). At least one laser source and at least one powder conveyor are connected to the coating tool 3.

The base body G is subsequently set in rapid rotation so that it rotates about the rotational axis R at a certain rotational speed n. The coating of the base body G begins at a radially inner position Gi, and is continued in the direction of a radially outer position Ga of the base body G via a radial feed motion V.

Simultaneously with the generation of the laser beam L, the mentioned powder conveyor is put into operation in such a way that the first powdered coating material P1 is conveyed with a powder mass flow m that is in a range of approximately 60 g/min to approximately 400 g/min, preferably in the range of approximately 225 g/min to approximately 400 g/min, and particularly preferably in the range of approximately 225 g/min to approximately 300 g/min. The first powdered coating material P1 is made up of powder grains having a spherical, i.e., ball-shaped, form and is made of a material corresponding to the first build-up layer B1 to be produced.

Depending on the instantaneous position of the coating tool 3, the rotational speed n of the base body G is adjusted in order to achieve a constant thickness of the build-up layer B1 over the entire surface of the planar side Fa to be coated.

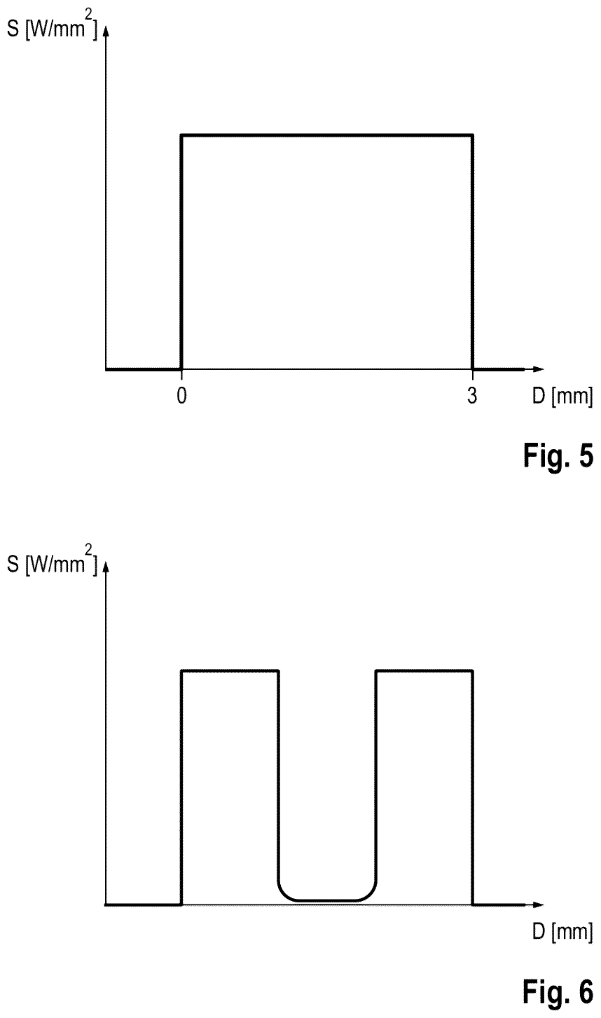

In the coating method, a radiation intensity S of the laser beam L (also see FIG. 5) is set in a range of approximately 700 W/m² to approximately 1700 W/mm², preferably in a range of approximately 1505 W/mm² to approximately 1700 W/mm². This ensures that overheating of the respective build-up layer B1 or B2 to be applied does not take place.

In the illustrated coating method, the coating material, i.e., the powdered coating material P1 or P2, is melted. For this purpose, the powdered coating material P1 or P2 is supplied in a targeted manner by the coating tool 3 to the laser beam L that strikes the base body G, i.e., the laser spot. At that location the powdered coating material P1 or P2 is melted and forms a molten pool SB.

In contrast, the base body G itself does not form a molten pool, and instead is only locally heated to a temperature just below its melting temperature. Therefore, unmelted particles of the powdered coating material P1 or P2 are not introduced into a melt of the base body G; rather, a molten pool SB made up of the particles of the powdered coating material P1 or P2 is deposited. At the immediate boundary surface between the molten coating material (P1 in the figure) and the locally intensely heated surface of the substrate (base body G here), a diffusion process results in very good bonding of the coating material (P1 here) to the substrate (base body G here), without increased blending of the involved materials taking place.

As a result of the powdered coating material P1 or P2 being brought into the laser beam L in the direction of or approximately in the direction of gravitational acceleration g, it can remain in the laser beam L as long as possible, and good melting can take place.

In a departure from the exemplary embodiment in FIG. 4, it is also conceivable to use a coating tool in which powdered materials can be supplied in two feed channels. Thus, the different powder components of the coating material P2 (powder particles of the iron alloy matrix on the one hand, and powder particles from tungsten carbide on the other hand) may be supplied in different feed sections. In particular, this allows these powder particles to be supplied at different speeds. This provides the advantage of being able to set the melting rate of the individual powder particles even more accurately if necessary. The powder particles made of tungsten carbide are preferably supplied at a higher speed than the powder particles of the iron alloy matrix. Thus, the fusion rate of the tungsten carbides may kept lower than the melting rate of the iron alloy matrix.

In a departure from the exemplary embodiment, it is also conceivable to use a coating tool that can generate multiple energy beams or laser beams that are directed onto the substrate. For example, it is conceivable for a portion of the overall radiation energy used to be decoupled and used for generating a second laser beam. The second laser beam, in the forward direction of the coating tool, may then preferably strike the substrate before the first laser beam, and may thus be used for precise, local preheating of the substrate.

FIG. 5 illustrates a possible radiation intensity S of the laser beam L over a diameter D of a laser spot which forms on the particular surface to be coated.

In the exemplary embodiment, a laser spot may be formed that has an outer diameter D in a range of approximately 2 mm to approximately 7 mm, preferably in a range of approximately 3.1 mm to approximately 7 mm, and very particularly preferably in a range of approximately 3.1 mm to approximately 5 mm. It is apparent that the laser intensity S remains virtually constant over the entire diameter D of the laser spot. The radiation intensity S of the laser beam L thus forms a so-called top hat profile (or also a rectangular profile).

Alternatively, a laser spot with a top hat ring profile may be very advantageously generated, as illustrated in FIG. 6. In a middle range of the laser spot, the laser intensity is greatly reduced, or drops to zero or essentially to zero. This has the advantage that the energy input introduced into the powder particles via the laser beam may be equalized. Moreover, the melting rate of the tungsten carbide particles may thus be further reduced, and embrittlement in the build-up layer B2 may be decreased.

It is noted that during the coating, the coating tool 3 is moved radially outwardly with a feed motion v at a speed of greater than approximately 90 m/min, preferably greater than approximately 100 m/min.

In addition, the feed motion v of the coating tool and a rotational speed of the brake element 1 are coordinated with one another in such a way that, during a complete rotation of the brake element 1 by 360 degrees, an overlap from a coating track that is applied during the rotation and a previously applied coating track which is in a range of approximately 70 percent to approximately 95 percent, preferably in a range of approximately 70 percent to approximately 90 percent, and particularly preferably in a range of approximately 70 percent to approximately 84 percent, is obtained. Overall, for each build-up layer (B1 or B2) this results in a helical profile of the applied layer tracks.

When the first build-up layer B1 is applied to the base body G as desired, the second layer B2 is correspondingly applied to a surface O of the first build-up layer B1.

The coating tool 3 is once again moved radially from the inside to the outside. However, for applying the second build-up layer B2, the second powdered coating material P2 is now supplied to the laser beam L. The second powdered coating material is also preferably present in powder grains having a spherical shape. As mentioned above, the material is made of a substance having a similar composition as the iron alloy 1.4404 and additional tungsten carbide particles.

In a departure from the tungsten carbide particles, it is also conceivable to use ceramic metallic materials or composite materials made of oxide ceramic, carbidic, or boridic particles in the iron alloy matrix E. For example, chromium carbides, titanium carbides, or also niobium carbides are conceivable. Alternatively, instead of the iron alloy matrix E, in particular nickel-based alloys or alternative iron-based alloys may be used.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A brake element for a motor vehicle, the brake element comprising:
a base body that is planar, at least in areas, to planar sides of which at least two build-up layers are applied in each case, at least in areas, the build-up layers forming a surface which, in a mounted state of the brake element on the motor vehicle, is used as a friction surface for a brake pad;
a bonding zone in which both a material of the base body and a material of a build-up layer adjacent thereto are present;
a first build-up layer that adjoins the base body; and
a second build-up layer that is applied to the first build-up layer, the second build-up layer being made of a composite of an iron alloy matrix with intercalated tungsten carbide particles,
wherein a proportion of a volume of the intercalated tungsten carbide particles to the volume of the iron alloy matrix is in a range of 1% to 19%.

2. The brake element according to claim 1, wherein the bonding zone has a thickness, substantially perpendicular to an areal extent of a planar side, that is less than 10 μm.

3. The brake element according to claim 1, wherein the first build-up layer, viewed substantially perpendicularly with respect to an areal extent of a planar side, has a thickness in a range of 50 μm to 350 μm.

4. The brake element according to claim 1, wherein the second build-up layer has a thickness in a range of 60 μm to 420 μm.

5. The brake element according to claim 1, wherein the first build-up layer is made of an austenitic chromium-nickel-molybdenum steel.

6. The brake element according to claim 1, wherein the material of the first build-up layer has material properties corresponding to the material 1.4404 according to the EN 10027-2 standard, or to a material 316L according to the AISI standard.

7. The brake element according to claim 1, wherein the iron alloy matrix is made of a material that has material properties corresponding to the material 1.4404 according to the EN 10027-2 standard, or to a material 316L according to the AISI standard.

8. A method for manufacturing a brake element according to claim 1, the method comprising:
directing at least one energy beam being onto a planar side of the base body of the brake element via at least one energy source;
supplying a first powdered coating material to a position that is acted on by the energy beam in order to melt the first coating material and coat the planar side of the base body with a first build-up layer; and
directing, after the first build-up layer is applied, at least one energy beam onto a surface of the first build-up layer via the at least one energy source, and a second powdered coating material is supplied to a position that is acted on by the energy beam in order to melt the second coating material and coat the first build-up layer with a second build-up layer,
wherein the powdered coating material is supplied at a powder mass flow in a range of 225 g/min to 400 g/min.

9. The method according to claim 8, wherein a radiation intensity of the energy beam for both build-up layers is held in a range of 700 W/mm² to 1700 W/mm².

10. The method according to claim 8, wherein the energy beam is delivered to the substrate such that a laser spot having an outer diameter in a range of 2 mm to 7 mm results at the area of impact of the energy beam on the particular substrate.

11. The method according to claim 8, wherein the application of the build-up layers takes place via a radial feed motion of a coating tool from the inside to the outside.

12. The method according to claim 11, wherein the radial feed motion of the coating tool takes place at a speed above 90 m/min.

13. The method according to claim 8, wherein a radial feed motion of the coating tool and a rotational speed of the brake element are coordinated with one another such that, during a complete rotation of the brake element, an overlap of a coating track that is applied during the rotation and a previously applied coating track in a range of 70% to 95% is obtained.

14. The method according to claim 8, wherein the energy source for generating the energy beam is operated with a power in a range between 6 KW and 30 KW, or in a range between 8 KW and 22 kW.

15. The method according to claim 8, wherein, in the production of the second build-up layer using the second powdered coating material, a powdered material containing tungsten carbide particles and a powdered material containing particles of the iron alloy matrix are supplied separately, the powdered material containing the tungsten carbide particles being supplied at a higher speed than the powdered material containing the particles of the iron alloy matrix.
